(19) United States
(12) Patent Application Publication
(10) Pub. No.: US 2021/0334651 A1
(43) Pub. Date: Oct. 28, 2021

(54) LEARNING POINT CLOUD AUGMENTATION POLICIES

(71) Applicant: Waymo LLC, Mountain View, CA (US)

(72) Inventors: Zhaoqi Leng, Milpitas, CA (US); Ekin Dogus Cubuk, Sunnyvale, CA (US); Barret Zoph, Sunnyvale, CA (US); Jiquan Ngiam, Mountain View, CA (US); Congcong Li, Cupertino, CA (US); Jonathon Shlens, San Francisco, CA (US); Shuyang Cheng, Santa Clara, CA (US)

(21) Appl. No.: 17/194,115

(22) Filed: Mar. 5, 2021

Related U.S. Application Data
(60) Provisional application No. 62/985,810, filed on Mar. 5, 2020.
(60) Provisional application No. 62/985,880, filed on Mar. 5, 2020.

(51) Int. Cl. G06N 3/08; G06F 17/18; G06K 9/62; G01S 17/894

(52) U.S. Cl. CPC G06N 3/08; G06F 17/18; G06K 9/00791; G06K 9/6262; G01S 17/894; G06K 9/6256

(57) ABSTRACT

Methods, systems, and apparatus, including computer programs encoded on a computer storage medium, for training a machine learning model to perform a machine learning task by processing input data to the model. For example, the input data can include image, video, or point cloud data, and the task can be a perception task such as classification or detection task. In one aspect, the method includes receiving training data including a plurality of training inputs; receiving a plurality of data augmentation policy parameters that define different transformation operations for transforming training inputs before the training inputs are used to train the machine learning model; maintaining a plurality of candidate machine learning models; for each of the plurality of candidate machine learning models: repeatedly determining an augmented batch of training data; training the candidate machine learning model using the augmented batch of the training data; and updating the maintained data.

### CROSS-REFERENCE TO RELATED APPLICATION

This application claims priority to U.S. Provisional Application No. 62/985,810, filed on Mar. 5, 2020 and U.S. Provisional Application No. 62/985,880, filed on Mar. 5, 2020. The disclosure of the prior applications are considered part of and are incorporated by reference in the disclosure of this application.

### BACKGROUND

This specification relates to autonomous vehicles. Autonomous vehicles include self-driving cars, boats, and aircraft. Autonomous vehicles use a variety of on-board sensors and computer systems to detect nearby objects and use such detections to make control and navigation decisions.

Some autonomous vehicles have computer systems that implement neural networks for object classification within data from sensors.

Neural networks, or for brevity, networks, are machine learning models that employ multiple layers of operations to predict one or more outputs from one or more inputs. In some cases, neural networks include one or more hidden layers situated between an input layer and an output layer. The output of each layer is used as input to another layer in the network, e.g., the next hidden layer or the output layer.

### SUMMARY

This specification describes a system implemented as computer programs on one or more computers in one or more locations that trains a machine learning model having a plurality of model parameters to perform a particular neural network task. In particular, the system trains the machine learning model to determine trained values of the model parameters using an iterative training process and by using different transformation operations. The transformation operations are used to transform training inputs before the training inputs are used to train the machine learning models.

The machine learning model can have any appropriate machine learning model architecture. For example, the machine learning model may be a neural network model, a random forest model, a support vector machine (SVM) model, a linear model, or a combination thereof.

The machine learning model can be configured to receive any kind of digital data input and to generate any kind of score, classification, or regression output based on the input.

For example, if the inputs to the machine learning model are images or features that have been extracted from images, the output generated by the machine learning model for a given image may be scores for each of a set of object categories, with each score representing an estimated likelihood that the image contains an image of an object belonging to the category. As another example, if the inputs to the machine learning model are images, the output generated by the machine learning model may be an object detection output that identifies regions in the image that are likely to depict an object that belongs to one of a set of one more categories of interest.

As another example, if the inputs to the machine learning model are 3-D point clouds generated by one or more LIDAR sensors, the output generated by the machine learning model may be may be scores for each of a set of object categories, with each score representing an estimated likelihood that the point cloud includes readings of an object belonging to the category. As another example, if the inputs to the machine learning model are point clouds generated by one or more sensors, the output generated by the machine learning model may be an object detection output that identifies regions in the 3-D space sensed by the one or more sensors that are likely to include an object that belongs to one of a set of one more categories of interest.

As another example, if the inputs to the machine learning model are Internet resources (e.g., web pages), documents, or portions of documents or features extracted from Internet resources, documents, or portions of documents, the output generated by the machine learning model for a given Internet resource, document, or portion of a document may be a score for each of a set of topics, with each score representing an estimated likelihood that the Internet resource, document, or document portion is about the topic.

As another example, if the inputs to the machine learning model are features of an impression context for a particular advertisement, the output generated by the machine learning model may be a score that represents an estimated likelihood that the particular advertisement will be clicked on.

As another example, if the inputs to the machine learning model are features of a personalized recommendation for a user, e.g., features characterizing the context for the recommendation, e.g., features characterizing previous actions taken by the user, the output generated by the machine learning model may be a score for each of a set of content items, with each score representing an estimated likelihood that the user will respond favorably to being recommended the content item.

As another example, if the input to the machine learning model is a sequence of text in one language, the output generated by the machine learning model may be a score for each of a set of pieces of text in another language, with each score representing an estimated likelihood that the piece of text in the other language is a proper translation of the input text into the other language.

As another example, if the input to the machine learning model is a sequence representing a spoken utterance, the output generated by the machine learning model may be a score for each of a set of pieces of text, each score representing an estimated likelihood that the piece of text is the correct transcript for the utterance. As another example, the task may be a keyword spotting task where, if the input to the machine learning model is a sequence representing a spoken utterance, the output generated by the machine learning model can indicate whether a particular word or phrase (“hotword”) was spoken in the utterance. As another example, if the input to the machine learning model is a sequence representing a spoken utterance, the output generated by the machine learning model can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the model output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, if the input to the machine learning model is data characterizing the state of an environment being interacted with by an agent, the output generated by the machine learning model can be a policy output that defines a control input for the agent. The agent can be, e.g., a real-world or simulated robot, a control system for an industrial facility, or a control system that controls a different kind of agent. For example, the output can include or define a respective probability for each action in a set of possible actions to be performed by the agent or a respective Q value, i.e., a return estimate, for each action in the set of possible actions. As another example, the output can identify a control input in a continuous space of control inputs.

Particular embodiments of the subject matter described in this specification can be implemented so as to realize one or more of the following advantages.

By training the machine learning models in a manner that optimizes model parameters and data augmentation policy parameters jointly, a system disclosed in this specification can train the machine learning model to generate outputs, e.g., perception outputs such as object detection or classification outputs, that are more accurate than those generated by models trained using conventional techniques, e.g., using manually designed data augmentation policies. Moreover, narrowing down the search space of possible data augmentation policy parameters to focus on specifically a subset of transformation operations at every iteration and for each model endows the system with overall robustness against inferior data augmentation parameters that may be selected during the training process. Compared with other conventional approaches, the system can thus make more efficient use of computational resources, e.g., memory, wall clock time, or both during training. The system can also train the machine learning model using orders of magnitude smaller amount of labeled data and, correspondingly, at orders of magnitude lower human labor cost associated with data labeling, while still ensuring a competitive performance of the trained model on a range of tasks that match or even exceed the state-of-the-art.

Data augmentation policies learned by the system are universally applicable to any type of data for any type of technical task that machine learning models may be applied to. For example, the system may be used to train a perception neural network for processing point cloud, image, or video data, for example to recognize objects or persons in the data. Deploying the perception neural network within an on-board system of a vehicle can be further advantageous, because the perception neural network in turn enables the on-board system to generate better-informed planning decisions which in turn result in a safer journey.

In some cases, data augmentation policies learned by the system can be used to train a machine learning model that performs well on data including 3-D point cloud data that specifically possesses one or more characteristics (e.g., weather, season, region, or illumination characteristics) without the need to collect more of that data at additional equipment or human labor costs for use in training the machine learning model. When deployed within the on-board system of the vehicle, the machine learning model can further enable the on-board system to generate better-informed planning decisions which in turn result in a safer journey, even when the vehicle is navigating through unconventional environments or inclement weather such as rain or snow.

In some cases, data augmentation policies learned by the system are transferrable between training data sets. That is, a data augmentation policy learned with reference to a first training data set can be used to effectively train a machine learning model on a second training data set (i.e., even if the data augmentation policy was not learned with reference to the second training data set). The transferability of the data augmentation policies learned by the training system can reduce consumption of computational resources, e.g., by enabling learned data augmentation policies to be re-used on new training data sets, rather than learning new data augmentation policies for the new training data sets.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows a block diagram of an example on-board system.

FIG. 2 shows an example of a machine learning model training system.

FIG. 3 shows another example of a machine learning model training system.

FIG. 4 is an illustration of an example point cloud augmentation policy.

FIG. 5 is an illustration of the effects of applying different transformation operations to an original point cloud.

FIG. 6 is a flow diagram of an example process for automatically selecting a point cloud augmentation policy and using the point cloud augmentation policy to train a machine learning model.

FIG. 7 a flow diagram of an example process for updating the population repository for a candidate machine learning model.

FIG. 8 is an illustration of an example iteration of generating new data augmentation policy parameters.

Like reference numbers and designations in the various drawings indicate like elements.

### DETAILED DESCRIPTION

This specification describes a system implemented as computer programs on one or more computers in one or more locations that trains a machine learning model having a plurality of model parameters to perform a particular neural network task. In particular, the system trains the machine learning model to determine trained values of the model parameters using an iterative training process and by using different transformation operations. The transformation operations are used to transform training inputs before the training inputs are used to train the machine learning models. The transformation operations can be used to increase the quantity, diversity, or both of the training inputs used in training the machine learning model, thereby resulting in the trained machine learning model performing the machine learning task more effectively (e.g., with greater prediction accuracy).

In some implementations, during the training of the machine learning model, the system additionally determines a “final” data augmentation policy by automatically searching through a space of possible data augmentation policies, e.g., by using a progressive population based augmentation technique. In this specification, a data augmentation policy is composed of a sequence of one or more different transformation operations.

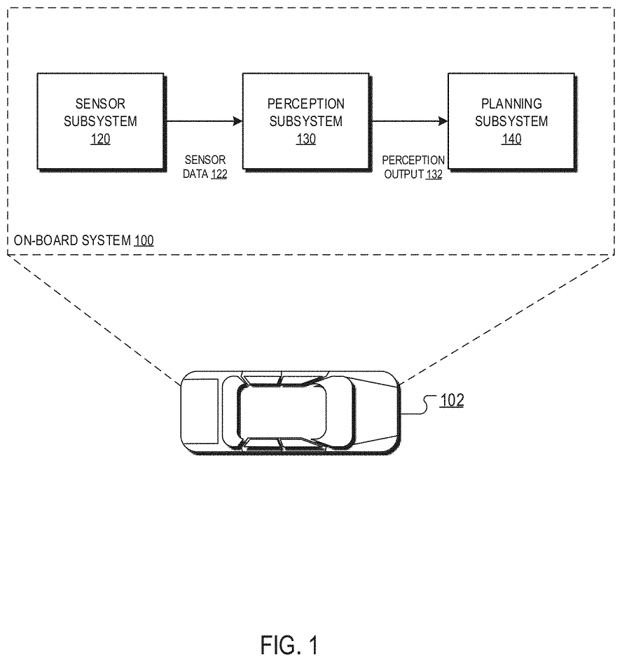

FIG. 1 is a block diagram of an example on-board system 100. The on-board system 100 is physically located on-board a vehicle 102. The vehicle 102 in FIG. 1 is illustrated as an automobile, but the on-board system 100 can be located on-board any appropriate vehicle type. The vehicle 102 can be a fully autonomous vehicle that makes fully-autonomous driving decisions or a semi-autonomous vehicle that aids a human operator. For example, the vehicle 102 can autonomously apply the brakes if a full-vehicle prediction indicates that a human driver is about to collide with a detected object, e.g., a pedestrian, a cyclist, another vehicle. While the vehicle 102 is illustrated in FIG. 1 as being an automobile, the vehicle 102 can be any appropriate vehicle that uses sensor data to make fully-autonomous or semi-autonomous operation decisions. For example, the vehicle 102 can be a watercraft or an aircraft. Moreover, the on-board system 100 can include components additional to those depicted in FIG. 1 (e.g., a control subsystem or a user interface subsystem).

The on-board system 100 includes a sensor subsystem 120 which enables the on-board system 100 to “see” the environment in a vicinity of the vehicle 102. The sensor subsystem 120 includes one or more sensors, some of which are configured to receive reflections of electromagnetic radiation from the environment in the vicinity of the vehicle 102. For example, the sensor subsystem 120 can include one or more laser sensors (e.g., LIDAR sensors) that are configured to detect reflections of laser light. As another example, the sensor subsystem 120 can include one or more radar sensors that are configured to detect reflections of radio waves. As another example, the sensor subsystem 120 can include one or more camera sensors that are configured to detect reflections of visible light.

The sensor subsystem 120 repeatedly (i.e., at each of multiple time points) uses raw sensor measurements, data derived from raw sensor measurements, or both to generate sensor data 122. The raw sensor measurements indicate the directions, intensities, and distances travelled by reflected radiation. For example, a sensor in the sensor subsystem 120 can transmit one or more pulses of electromagnetic radiation in a particular direction and can measure the intensity of any reflections as well as the time that the reflection was received. A distance can be computed by determining the time which elapses between transmitting a pulse and receiving its reflection. Each sensor can continually sweep a particular space in angle, azimuth, or both. Sweeping in azimuth, for example, can allow a sensor to detect multiple objects along the same line of sight.

In particular, the sensor data 122 includes point cloud data that characterizes the latest state of an environment (i.e., an environment at the current time point) in the vicinity of the vehicle 102. A point cloud is a collection of data points defined by a given coordinate system. For example, in a three-dimensional coordinate system, a point cloud can define the shape of some real or synthetic physical system, where each point in the point cloud is defined by three values representing respective coordinates in the coordinate system, e.g., (x, y, z) coordinates. As another example, in a three-dimensional coordinate system, each point in the point cloud can be defined by more than three values, wherein three values represent coordinates in the coordinate system and the additional values each represent a property of the point of the point cloud, e.g., an intensity of the point in the point cloud. In this specification, for convenience, a “point cloud” will refer to a four-dimensional point cloud, i.e. each point is defined by four values, but in general a point cloud can have a different dimensionality, e.g. three-dimensional or five-dimensional. Point cloud data can be generated, for example, by using LIDAR sensors or depth camera sensors that are on-board the vehicle 102.

The on-board system 100 can provide the sensor data 122 generated by the sensor subsystem 120 to a perception subsystem 130 for use in generating perception outputs 132.

The perception subsystem 130 implements components that identify objects within a vicinity of the vehicle. The components typically include one or more fully-learned machine learning models. A machine learning model is said to be “fully-learned” if the model has been trained to compute a desired prediction when performing a perception task. In other words, a fully-learned model generates a perception output based solely on being trained on training data rather than on human-programmed decisions. For example, the perception output 132 may be a classification output that includes a respective object score corresponding to each of one or more object categories, each object score representing a likelihood that the input sensor data characterizes an object belonging to the corresponding object category. As another example, the perception output 132 can include data defining one or more bounding boxes in the sensor data 122, and optionally, for each of the one or more bounding boxes, a respective confidence score that represents a likelihood that an object belonging to an object category from a set of one or more object categories is present in the region of the environment shown in the bounding box. Examples of object categories include pedestrians, cyclists, or other vehicles near the vicinity of the vehicle 102 as it travels on a road.

The on-board system 100 can provide the perception outputs 132 to a planning subsystem 140. When the planning subsystem 140 receives the perception outputs 132, the planning subsystem 140 can use the perception outputs 132 to generate planning decisions which plan the future trajectory of the vehicle 102. The planning decisions generated by the planning subsystem 140 can include, for example: yielding (e.g., to pedestrians), stopping (e.g., at a “Stop” sign), passing other vehicles, adjusting vehicle lane position to accommodate a bicyclist, slowing down in a school or construction zone, merging (e.g., onto a highway), and parking. The planning decisions generated by the planning subsystem 140 can be provided to a control system (not shown in the figure) of the vehicle 102. The control system of the vehicle can control some or all of the operations of the vehicle by implementing the planning decisions generated by the planning system. For example, in response to receiving a planning decision to apply the brakes of the vehicle, the control system of the vehicle 102 may transmit an electronic signal to a braking control unit of the vehicle. In response to receiving the electronic signal, the braking control unit can mechanically apply the brakes of the vehicle.

In order for the planning subsystem 140 to generate planning decisions which cause the vehicle 102 to travel along a safe and comfortable trajectory, the on-board system 100 must provide the planning subsystem 140 with high quality perception outputs 132. In various scenarios, however, accurately classifying or detecting objects within point cloud data can be challenging. This is oftentimes due to insufficient diversity or inferior quality of point cloud training data, i.e., the data that is used in training the machine learning models to perform point cloud perception tasks. In this specification, data diversity refers to the total amount of different characteristics that are possessed by the training data which can include, for example, weather, season, region, or illumination characteristics. For example, a machine learning model that has been specifically trained on training data that is derived from primarily daytime driving logs may fail to generate high quality perception outputs when processing nighttime sensor data. As another example, a machine learning model that has been specifically trained on training data that is primarily collected under normal weather conditions may experience degraded performance on perception tasks under adverse or inclement weathers conditions such as rain, fog, hail, snow, dust, and the like.

Thus, to generate perception outputs with greater overall prediction accuracy, the perception subsystem 130 implements one or more machine learning models that have been trained using respective point cloud augmentation policies. The point cloud augmentation policy can be used to increase the quantity and diversity of the training inputs used in training the machine learning model, thereby resulting in the trained machine learning model performing the point cloud perception tasks more effectively. That is, once trained, the machine learning model can be deployed within the perception subsystem 130 to accurately detect or classify objects within point cloud data generated by the sensor subsystem 120 without using the point cloud augmentation policy. Generating a trained machine learning model using a point cloud augmentation policy will be described in more detail below.

It should be noted that, while the description in this specification largely relates to training a machine learning model to perform a perception task by processing point cloud data, the described techniques can also be used for training the model to perform other appropriate machine learning tasks, including, for example, localization, mapping, and planning tasks.

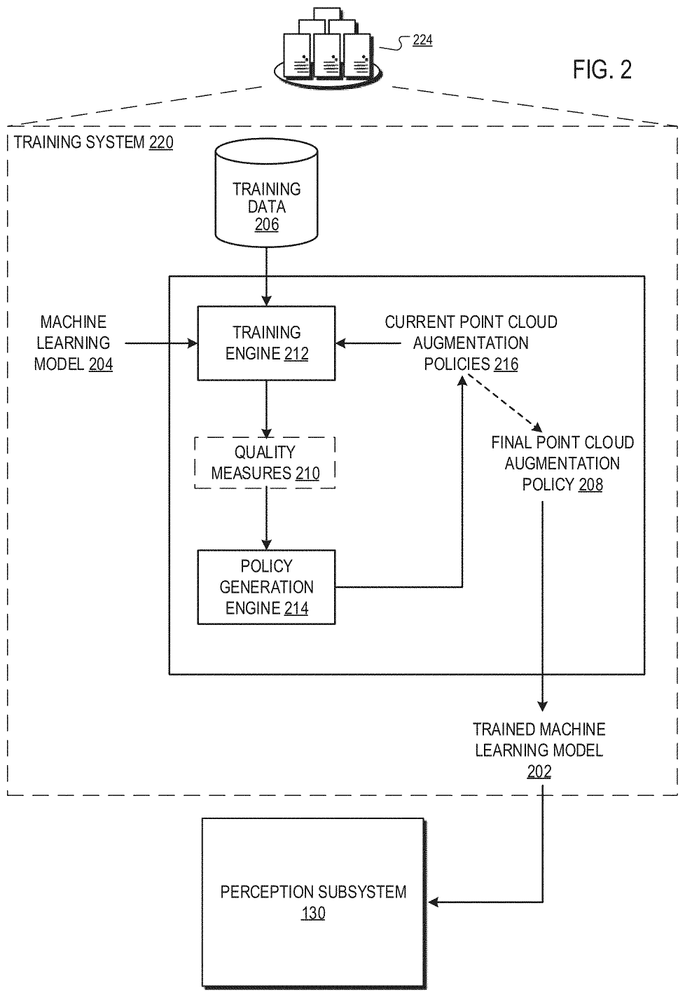

FIG. 2 shows an example of a machine learning model training system 220. The training system 220 is an example of a system implemented as computer programs on one or more computers in one or more locations in which the systems, components, and techniques described below are implemented.

To allow the perception subsystem 120 to accurately identify objects within point cloud data, the training system 220 can generate a trained machine learning model 102 to be included in the perception subsystem 130 and that has been trained using a point cloud augmentation policy. While the perception subsystem 130 may be implemented on-board a vehicle as described above, the training system 220 is typically hosted within a data center 224, which can be a distributed computing system having hundreds or thousands of computers in one or more locations.

The training system 220 is configured to generate the trained machine learning model 202 by training a machine learning model 204 using: (i) the training data 206, and (ii) a “final” point cloud augmentation policy 208. As will be described in more detail below, the training system 220 identifies the final point cloud augmentation policy 208 by searching a space of possible point cloud augmentation policies.

The training data 206 is composed of multiple training examples, where each training example specifies a training input and a corresponding target output. The training input includes a point cloud. The target output represents the output that should be generated by the machine learning model by processing the training input. For example, the target output may be a classification output that specifies a category (e.g., object class) corresponding to the input point cloud, or a regression output that specifies one or more continuous variables corresponding to the input point cloud (e.g., object bounding box coordinates).

The machine learning model 204 can have any appropriate machine learning model architecture. For example, the machine learning model may be a neural network model, a random forest model, a support vector machine (SVM) model, a linear model, or a combination thereof.

The training system 220 can receive the training data 206 and data defining the machine learning model 204 in any of a variety of ways. For example, the training system 220 can receive training data 206 or the data defining the machine learning model 204 as an upload from a remote user of the training system 220 over a data communication network, e.g., using an application programming interface (API) made available by the system 220. As another example, the training system 220 can receive an input from a user specifying which data that is already maintained by the training system 220 (e.g., in one or more physical data storage devices) should be used as the training data 206 or the data defining the machine learning model 204.

A point cloud augmentation policy is defined by a set of parameters (referred to in this document as “point cloud augmentation policy parameters”) that specify a procedure for transforming training inputs that are included in the training data 206 before the training inputs are used to train the machine learning model, i.e., are processed by the model during the training.

The procedure for transforming the training inputs generally includes applying one or more operations (referred to in this document as “transformation operations”) to the point cloud data included in the training inputs. The operations may be any appropriate sort of point cloud processing operations, for example, intensity perturbing operations, jittering operations, dropout operations, or a combination thereof. The point cloud augmentation policy parameters may specify which types of transformation operations should be applied, with which magnitude, or with what probability, or both.

Briefly, the training system 220 can implement various search techniques to identify point cloud augmentation policies with high “quality measures” from a space of possible point cloud augmentation policies. The quality measure 210 of a point cloud augmentation policy characterizes the performance (e.g., prediction accuracy) of a “candidate (or candidate) machine learning model” trained using the point cloud augmentation policy. For convenience, a higher quality measure will be understood in this document as implying a better performance (e.g., higher prediction accuracy).

In some implementations, the candidate machine learning model is an instance of the machine learning model 204 that is used specifically during the policy search process. In other words, each candidate machine learning model may have the same architecture as the machine learning model 204, but the respective model parameters values generally vary from each other. Alternatively, in some other implementations, the candidate machine learning model is a simplified instance of the machine learning model 204 and thus requires less computation during the policy search process. For example, each candidate machine learning model may have fewer layers, fewer parameters, or both than the machine learning model 204.

The training system 220 may determine the quality measure of a point cloud augmentation policy by evaluating the performance of a candidate machine learning model trained using the point cloud augmentation policy on “evaluation data”. For example, the training system 220 can determine the quality measure 210 based on an appropriate performance measure of the trained candidate machine learning model on the evaluation data, e.g., a F1 score or a Matthews correlation coefficient (in the case of a classification task), a mean average precision (mAP) score (in the case of a detection or segmentation task), a squared-error or absolute error (in the case of a regression task), or a combination thereof.

The evaluation data is composed of a plurality of training inputs that were not used in training the machine learning model. In addition, if trained specifically on the training data, i.e., without using the point cloud augmentation policy, the machine learning model 204 typically would fail to attain at least a threshold level of performance on the perception task by processing the evaluation data. For example, the evaluation data can be derived from primarily driving logs of vehicles navigating through unconventional environments or inclement weather such as rain or snow.

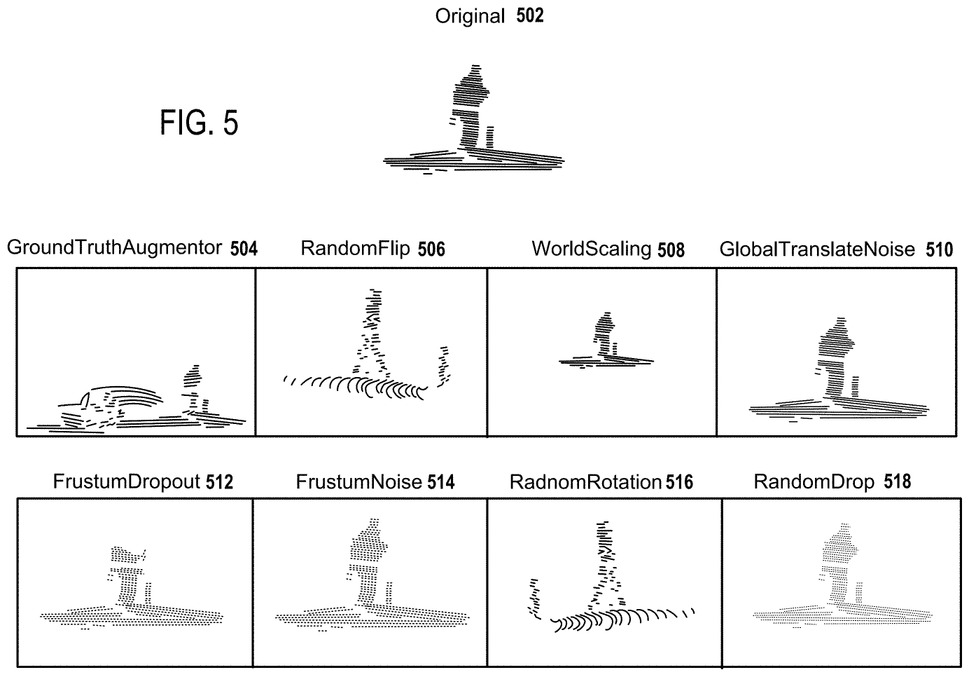

As used throughout this document and described in more detail with reference to FIG. 5, the space of possible point cloud augmentation policies refers to the space parametrized by the possible values of the point cloud augmentation policy parameters.

The training system 220 includes a training engine 212 and a policy generation engine 214.

At each of multiple iterations, referred to in this specification as “time steps”, the policy generation engine 214 generates one or more “current” point cloud augmentation policies 216. For each current point cloud augmentation policy 216, the training system 220 uses the training engine 212 to train a candidate machine learning model using the current point cloud augmentation policy and thereafter determines a quality measure 210 of the current point cloud augmentation policy. Optionally, the policy generation engine 214 uses the quality measures 210 of the current point cloud augmentation policies 216 to improve the expected quality measures of the point cloud augmentation policies to be generated for the next time step.

Training a machine learning model refers to determining adjusted (e.g., trained) values of the parameters of the machine learning model from initial values of the parameters of the machine learning model. The training engine 212 may train each candidate machine learning model starting from, e.g., randomly selected or default initial values of the machine learning model parameters, and until, e.g., a fixed number of training iterations are completed.

Generally, a candidate machine learning model can be trained using a point cloud augmentation policy by transforming the training inputs of existing training examples to generate “new” training examples, and using the new training examples (instead of or in addition to the existing training examples) to train the candidate machine learning model. For example, a point cloud included in the training input of a training example can be transformed by applying one or more point cloud transformation operations specified by the point cloud augmentation policy to the point cloud.

In some cases, the training input of a training example can be transformed (e.g., in accordance with a point cloud augmentation policy) while maintaining the same corresponding target output. For example, for a point cloud classification task where the target output specifies a type of object depicted in the training input, applying point cloud transformation operations (e.g., intensity perturbing operations, jittering operations, dropout operations, and the like) to the point cloud included in the training input would not affect the type of object depicted in the point cloud. Therefore, in this example, the transformed training input would correspond to the same target output as the original training input.

However, in certain situations, transforming the training input of a training example may also require changing the target output of the training example. In one example, the target output corresponding to a training input may specify coordinates of a bounding box that encloses an object depicted in the point cloud of the training input. In this example, applying a translation operation to the point cloud of the training input would require applying the same translation operation to the bounding box coordinates specified by the target output.

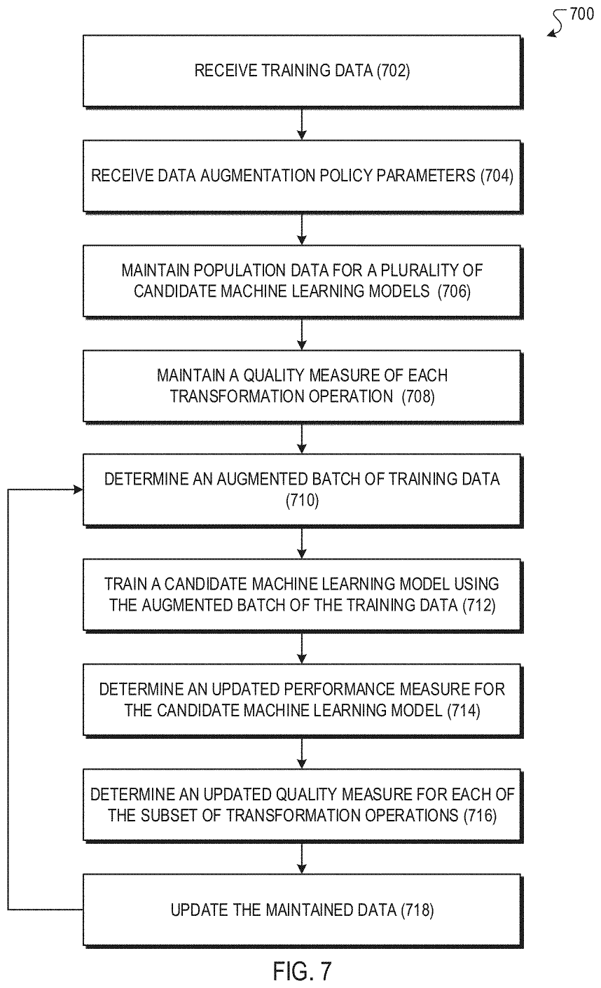

The specific operations performed by the training engine 212 to train the candidate machine learning model using a point cloud augmentation policy depend on the architecture of the machine learning model 204, e.g., whether the machine learning model 204 is a neural network model or a random forest model. An example of training a neural network model using a point cloud augmentation policy is described in more detail with reference to FIG. 7.

In general, the policy generation engine 214 can use any of a variety of techniques to search the space of possible point cloud augmentation policies.

For example, the policy generation engine 214 generates current point cloud augmentation policies using a random search technique. That is, at each time step, the engine 214 generates a current point cloud augmentation policy 216 with some measure of randomness from the space of possible point cloud augmentation policies, i.e., by randomly sampling a set of point cloud augmentation policy parameters that in turn defines the current point cloud augmentation policy.

As another example, the policy generation engine 214 generates current point cloud augmentation policies using a policy generation neural network, referred to in this document as a “policy” network. The policy network is typically a recurrent neural network that includes one or more recurrent neural network layers, e.g., long short-term memory (LSTM) layers or gated recurrent unit (GRU) layers. In particular, the policy network is configured to generate policy network outputs that each include a respective output at each of multiple output positions and each output position corresponds to a different point cloud augmentation policy parameter. Thus, each policy network output includes, at each output position, a respective value of the corresponding point cloud augmentation policy parameter. Collectively, the values of the point cloud augmentation policy parameters specified by a given policy network output define a current point cloud augmentation policy.

In this example implementation, at each time step, the policy generation engine 214 uses the policy network to generate one or more policy network outputs in accordance with the current values of the policy network parameters, each of which define a respective current point cloud augmentation policy 216. For each current point cloud augmentation policy 216 generated at a time step, the training system 220 trains a candidate machine learning model using the current point cloud augmentation policy 216 and thereafter determines a respective quality measure 210 of the trained machine learning model (as described earlier). The training engine 212 then uses the quality measures 210 as a reward signal to update the current values of the policy network parameters using a reinforcement learning technique. That is, the training engine 212 adjusts the current values of the policy network parameters by training the policy network to generate policy network outputs that result in increased quality measures of the corresponding point cloud augmentation policies using a reinforcement learning technique. For example, the training engine 212 trains the policy network using a policy gradient technique which can be a REINFORCE technique or a Proximal Policy Optimization (PPO) technique.

As yet another example, the policy generation engine 214 generates multiple current point cloud augmentation policies in parallel by using a population based training technique. Specifically, at each time step, the policy generation engine 214 trains multiple instances of candidate machine learning models that each use a different current point cloud augmentation policy 216 in parallel. At the end of the time step, for every pair of candidate machine learning models, the training engine 212 can then compare the quality measures of two models together and determine a better performing model. The policy parameters that define current point cloud augmentation policy 216 used in training the winning “parent” candidate model can be mutated and used to reproduce a new current point cloud augmentation policy 216 for use in training a “child” candidate model in a subsequent time step.

In this example implementation, training these candidate models using the population based training technique further allows the engine 214 to derive respective schedules of changes of point cloud augmentation policy parameters over the course of multiple time steps in which the candidate models are trained.

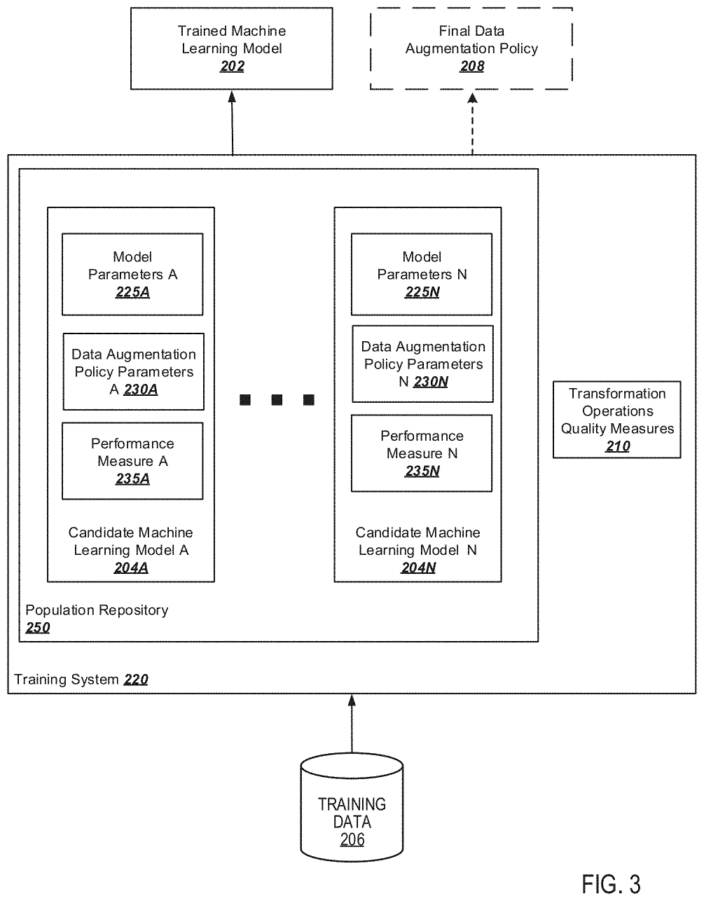

In this example implementation, the population based training technique can, in some cases, be a progressive population based training technique, such that the system gradually narrows down the entire space to a smaller subspace composed of only a set of possible point cloud augmentation policy parameters defining one or more transformation operations that have been shown to be more effective, in terms of quality measures 210 or some other metric derived from the quality measure. This allows the system to make more efficient use of computational resources, e.g., memory, wall clock time, or both during training. Progressive population based training is described further below with reference to FIGS. 3 and 7-8.

The training system 220 may continue generating point cloud augmentation policies until a search termination criterion is satisfied. For example, the training system 220 may determine that a search termination criterion is satisfied if point cloud augmentation policies have been generated for a predetermined number of time steps. As another example, the training system 220 may determine that a search termination criterion is satisfied if the quality measure of a generated point cloud augmentation policy satisfies a predetermined threshold.

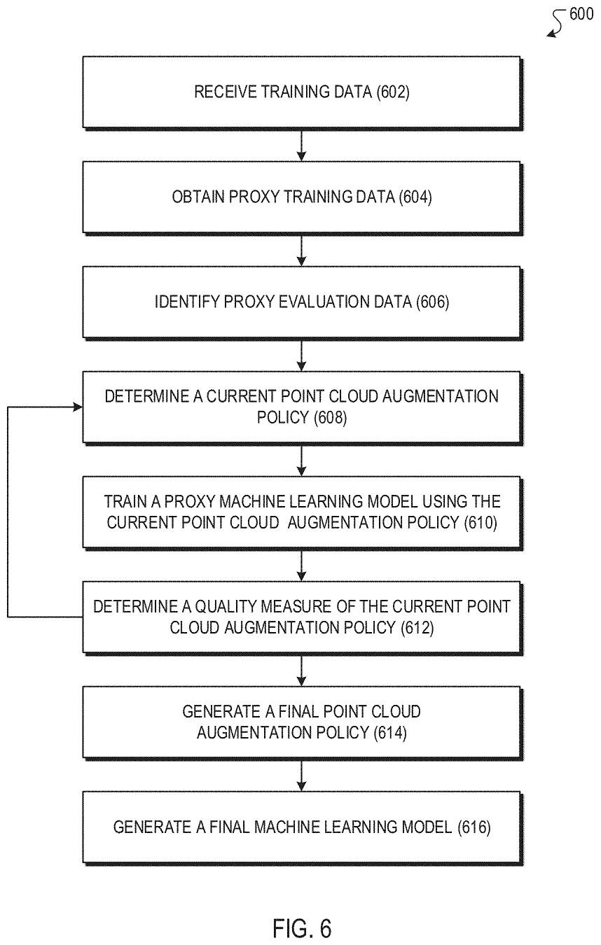

After determining that a search termination criterion is satisfied, the training system 220 determines a final point cloud augmentation policy based on the respective quality measures 210 of the generated point cloud augmentation policies. For example, the training system 220 may select the point cloud augmentation policy generated by the training system 220 with the highest quality measures as the final point cloud augmentation policy. As another example, which will be described in more detail with reference to FIG. 6, the training system 220 may combine a predetermined number (e.g., 5) of point cloud augmentation policies generated by the training system with the highest quality measures to generate the final point cloud augmentation policy 208.

The training system 220 can generate the trained machine learning model 102 by training an instance of the machine learning model 204 on the training data 206 using the final point cloud augmentation policy 208.

Once trained, the training system 220 can provide, e.g., by a wired or wireless connection, data specifying the trained machine learning model 202, e.g., the trained values of the parameters of the machine learning model and data specifying the architecture of the machine learning model, to the on-board system 100 of vehicle 102 for use in detecting or classifying objects within point cloud data. The parameters of the machine learning model will be referred to in this specification as “model parameters.” In cases where the final point cloud augmentation policy 208 may be transferrable to other data (e.g., another set of point cloud training data), the training system 200 can also output data specifying the final policy 208 in a similar manner, e.g., to another system.

FIG. 3 shows another example of a machine learning model training system 220. The system 220 is an example of a system implemented as computer programs on one or more computers in one or more locations in which the systems, components, and techniques described below are implemented. In the example of FIG. 3, the system 220 implements a progressive population-based machine learning model training scheme.

As described above, the training system 220 can generate output data specifying a trained machine learning model 202 using the training data 206 and, in some implementations, the final data augmentation policy 208.

The training system 220 implements a search algorithm to identify data augmentation policy parameters as well as associated values with high “quality measures” from an entire space of possible point cloud augmentation policy parameters. The point cloud augmentation policy parameters can define: (i) the type of a transformation operation (e.g., intensity perturbing operations, jittering operations, dropout operations, etc.), (ii) the magnitude of the transformation operation, or (iii) the probability of applying the transformation operation. Each point cloud augmentation policy parameter may have a predetermined set of possible values. In this way, the point cloud augmentation policy parameters can specify which transformation operations should be applied, with which magnitude, or with what probability, or both

In particular, the training system 220 employs a progressive population-based augmentation technique, such that the system gradually narrows down the entire space to a smaller subspace composed of only a set of possible data augmentation policy parameters defining one or more transformation operations that have been shown to be more effective. Measuring the effectiveness (referred to below as the “quality measure”) of a transformation operation will be described further below, but, in brief, the quality measure characterizes the performance (e.g., prediction accuracy) of a machine learning model trained on training inputs that have been augmented using at least the transformation operation. In general, a better performance (e.g., higher prediction accuracy) of the machine learning model will be understood in this document as implying a higher quality measure of a transformation operation using in training the machine learning model.

To generate the trained machine learning model 202 and to determine the final data augmentation policy 208, the training system 220 maintains a population repository 250 storing a plurality of candidate machine learning models 204A-N (referred to in this specification as the “population”). The population repository 250 is implemented as one or more logical storage devices in one or more physical locations or as logical storage space allocated in one or more storage devices in one or more physical locations. At any given time during training, the repository 250 stores data specifying the current population of the candidate machine learning models 204A-N.

In particular, the population repository 250 stores, for each candidate machine learning model 204A-N in the current population, a set of maintained values that defines the respective candidate machine learning models. The set of maintained values includes model parameters, data augmentation policy parameters, and a performance measure for each candidate machine learning models 204A-N (e.g., for candidate machine learning model A 204A, the set of maintained values includes model parameters A 225A, data augmentation policy parameters A 230A that define a sequence of one or more transformation operations used in training the candidate machine learning model A 204A, and a performance measure A 235A of the candidate machine learning model A 204A). During training, the network parameters, the data augmentation policy parameters, and the performance measure for a candidate machine learning model are updated in accordance with training operations, including an iterative training process and a progressive population-based augmentation process, as will be discussed further below.

Generally, the model parameters 225 are values that impact the operations performed by the candidate machine learning model and are adjusted as part of the iterative training process. In one example, if the machine learning models are configured as neural networks, then the model parameters of a machine learning model can include (i) values of weight matrices and, in some cases, bias vectors, of the fully-connected layers of the neural network and (ii) values of kernels of the convolutional layers in the neural network.

The data augmentation policy parameters 230 that specify a procedure of one or more transformation operations for transforming training inputs before the training inputs are used to train the candidate machine learning models 204 are adjusted as part of the progressive population-based augmentation process.

The training system 220 may determine the performance measure 235 of a candidate machine learning model trained using the one or more transformation operations defined by the data augmentation policy parameters 130 by evaluating the performance of the candidate machine learning model on the evaluation data that, for example, includes a set of training inputs that were not used in training the machine learning model.

The training system 220 also maintains, e.g., at part of or separately from the population repository 250, a corresponding quality measure 210 for each type of the transformation operation. The quality measure of the type of transformation operation can be determined from the performance measure of a candidate machine learning model trained using at least a transformation operation of this type. For performance measures where a lower value indicates better performance of the trained machine learning model (e.g., squared-error performance measures), the quality measure of the transformation operation may be inversely proportional to the performance measure (i.e., so better performance still imply higher quality measures). In this way, the quality measure for each transformation operation generally represents the performance of the candidate machine learning model on the particular machine learning task as a result of training the candidate machine learning model using at least the transformation operation.

The training system 220 trains each candidate machine learning model 204A-N by repeatedly performing iterations of an iterative training process to determine updated model parameters for the respective candidate machine learning model. At certain points during the iterative training process the training system 220 also updates the repository 250 and the maintained quality measures 210 for the transformation operations by performing additional training operations, including the progressive population-based augmentation process, as will be discussed further below.

At each time steps, the training system 220 generates, for each candidate machine learning model 204A-N, a plurality of “current” point cloud augmentation policy parameters that define a sequence of one or more “current” transformation operations to be used in training the candidate machine learning model during this time step.

To begin the training process, the training system 220 pre-populates the population repository 250 with a plurality of candidate machine learning models 204A-N for performing the specified machine learning task. In some implementations, the training system 220 randomly initializes model parameters 225A-N and data augmentation policy parameters 230A-N for each candidate machine learning model 204A-N.

For example, the training system 220 randomly initializes the data augmentation policy parameters for each candidate machine learning model 204A-N by first sampling, e.g., with uniform randomness, one or more data augmentation policy parameters that define one or more types of the transformation operations, and then sampling other data augmentation policy parameters that define, for each of the one or more types of the transformation operations, that the transformation operation should be applied with which magnitude, with what probability, or both, such that the candidate machine learning model 204A-N are trained on training inputs initially augmented using different transformation operations.

Each candidate machine learning model 204A-N is an architecture that receives inputs that conform to the machine learning task (i.e., inputs that have the format and structure of the training examples in the training data 206) and generates outputs that conform to the machine learning task (i.e., outputs that have the format and structure of the target outputs in the training data 206).

For some machine learning tasks, each candidate machine learning model 120A-N needs to be trained jointly with one or more other machine learning models. For example, in a generative adversarial machine learning task, the training system 220 trains a candidate neural network with one other neural network (e.g., a candidate generator neural network and a candidate discriminator neural network). The training system 220 then generates data specifying a pair of trained neural networks (e.g., a trained generator neural network and a trained discriminator neural network). For these machine learning tasks, the training system 220 maintains for each candidate machine learning model 204A-N, the maintained values of the respective one or more other machine learning models, in the population repository 250.

The training system 220 can execute the training operations for each candidate machine learning model 204A-N in parallel, asynchronously, and in a decentralized manner. In some implementations, each candidate machine learning model 204A-N is assigned a respective computing unit for executing population based training. The computing units are configured so that they can operate independently of each other. A computing unit may be, for example, a computer, a core within a computer having multiple cores, or other hardware or software within a computer capable of independently performing the computation required by the training system 220 for executing the iterative training process and updating the repository 250 for each candidate machine learning model 204A-N. In some implementations, only partial independence of operation is achieved, for example, because the training system 220 executes training operations for different candidate machine learning models that share some resources.

For each of the candidate machine learning models 204A-N in the current population, the training system 220 executes an iterative training process for training each of the candidate machine learning models 204A-N. Additional training operations are necessary to adjust the data augmentation policy parameters that define different transformation operations used in training the candidate machine learning models 204A-N and are discussed with respect to FIG. 5, below.

The iterative training process optimizes the model parameters 225A-N for the population of candidate machine learning models 204A-N. In some implementations, the iterative training process optimizes the model parameters 225A-N for the population of candidate machine learning models 204A-N in an iterative manner by using a gradient-based optimization technique (e.g., stochastic gradient descent on some objective function).

Training operations on the candidate machine learning models 204A-N by the training system 220 include operations to update the population repository 250 with new model parameters, new data augmentation policy parameters, and a new performance measure for each candidate machine learning model 204A-N. Additionally, the training operations include operations to update the quality measures 210 for different types of the transformation operations, e.g., based on the new performance measure of a candidate machine learning model trained using at least a transformation operation of a given type.

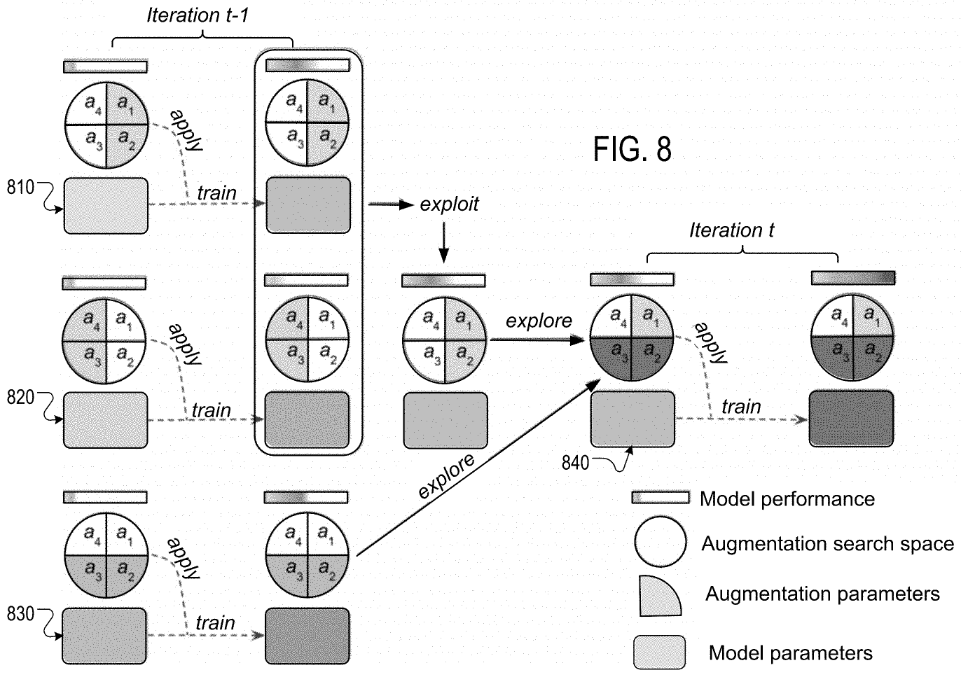

At the end of the time step, for every pair of trained candidate machine learning models, the system can compare the performance measures 235 of two models together and determine a better performing model. The current data augmentation policy parameters that define the one or more current transformation operations used in training the winning “parent” candidate machine learning models can be mutated and used to reproduce new current data augmentation policy parameters which define new transformation operations for use in training a “child” candidate machine learning models in a subsequent time step. By periodically and jointly updating the population repository 250 and the transformation operations quality measures 210 during the iterative training process, the candidate machine learning models 204A-N benefit from performance of the population. In some implementations, data augmentation policy parameter mutation and reproduction can follow an exploit—explore scheme, as will be described further below with reference to FIGS. 7-8.

After criteria are satisfied for ending execution of the training operations, (i.e., the training system 220 determines that training is over, e.g., based on some performance criteria) the training system 220 selects an optimal candidate machine learning model from the candidate machine learning models 204A-N. In particular, in some implementations, the training system 220 selects the candidate machine learning model in the population that has the best performance measure. The training system 220 can determine the candidate machine learning model in the population with the best performance measure by comparing each performance measure 235A-N for each candidate machine learning model 204A-N and, for example, selecting the candidate neural network with the highest performance measure.

Of course, a machine learning model trained by using the training system 220 of FIG. 3 can be additionally or alternatively deployed at a different subsystem of the on-board system 100, or at another system different from the on-board system 100, and configured to perform a different task. For example, the training system 220 of FIG. 3 can train a machine learning model configured to receive any kind of digital data input and to generate any kind of score, classification, or regression output based on the input.

For example, the inputs can include text data, image or video data, and the system training system 220 can automatically and progressively search through a space of possible data augmentation policies that are appropriate for the particular input data type or modality. For example, if the inputs include text data, then the data transformation operations may be any appropriate sort of text processing operations, for example, word or punctuation removal operations, masking operations, partitioning operations, or a combination thereof. As another example, if the inputs include image data, then the data transformation operations may be any appropriate sort of image processing operations, for example, translation operations, rotation operations, shearing operations, color inversion operations, or a combination thereof.

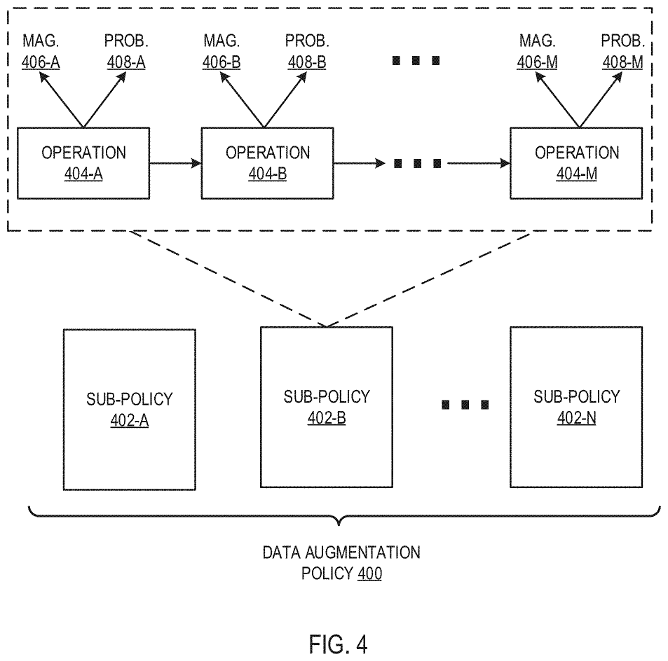

FIG. 4 is an illustration of an example point cloud augmentation policy. The point cloud augmentation policy 400 is composed of one or more “sub-policies” 402-A-402-N. Each sub-policy, in turn, is composed of one or more transformation operations (e.g., 404-A-404-M), e.g., data point processing operations, e.g., intensity perturbing operations, jittering operations, or dropout operations. As such, each point cloud augmentation policy 400 can be said to define a sequence of multiple transformation operations. Each transformation operation has an associated magnitude (e.g., 406-A-406-M) and an associated probability (e.g., 408-A-408-M). For convenience, a transformation operation (e.g., 404-A) and its corresponding magnitude (e.g., 406-A) and probability (e.g., 408-A) can be collectively referred to in this document as a “transformation tuple”.

The magnitude of a transformation operation is an ordered collection of one or more numerical values that specifies how the transformation operation should be applied to a training input. For example, the magnitude of a rotation operation may specify the number of radians by which a point cloud should be rotated along a predetermined axis. As another example, the magnitude of an intensity perturbation operation may specify the absolute value of random noise to be added to respective coordinates of data points in a point cloud.

To transform a training input using the point cloud augmentation policy 400, a transformation operation in the sequence of transformation operations is applied to the training input in accordance with the ordering of the transformation operations in the sequence. Further, the transformation operation is applied to the training input with the probability and the magnitude associated with the transformation operation.

FIG. 5 is an illustration of the effects of applying different point cloud transformation operations 504-518 to an original point cloud 502, with detailed descriptions of the transformation operations described below in Table 1.

For convenience, each type of point cloud transformation operation will be described as being applied to a particular training input, or more precisely, to the point cloud that is composed of a collection of data points and that is specified by the particular training input.

For example, as a result of applying a ground truth augmentor operation 504 to the original point cloud 502, point cloud data characterizing a leftward-headed vehicle is now added to the original point cloud 502.

TABLE 1

| Operation Name | Description |
|---|---|
| GroundTruthAugmentor | Augment the bounding boxes from a ground |
| | truth data base (<25 boxes per scene) |
| RandomFlip | Randomly flip all points along the Y axis. |
| WorldScaling | Apply global scaling to all ground truth |
| | boxes and all points. |
| RandomRotation | Apply random rotation to all ground truth |
| | boxes and all points. |
| GlobalTranslateNoise | Apply global translating to all ground truth |
| | boxes and all points along x/y/z axis. |
| FrustumDropout | All points are first converted to spherical |
| | coordinates, and then a point is randomly |
| | selected. All points in the frustum around |
| | that point within a given phi, theta angle |
| | width and distance to the original greater |
| | than a given value are dropped randomly. |
| FrustumNoise | Randomly add noise to points within a frustum |
| | in a converted spherical coordinates. |
| RandomDropout | Randomly dropout all points. |

The point cloud augmentation policy parameters may further specify that a point cloud transformation operation should be applied with which magnitude, with what probability, or both. This is described below in Table 2.

The magnitude of a point cloud transformation operation may have a predetermined number of possible values that are, e.g., uniformly spaced throughout a continuous range of allowable values. In one example, for a rotation operation, the continuous range of allowable values may be [0, π/4] radians. The probability of applying a transformation operation may have a predetermined number of possible values that are, e.g., uniformly spaced throughout a given range. In one example, the possible values of the probability of applying a dropout operation may be between [0,1].

TABLE 2

| Operation Name | Parameter Name | Range |
|---|---|---|
| GroundTruthAugmentor | vehicle sampling probability | [0, 1] |
| | pedestrian sampling | [0, 1] |
| | probability | |
| | cyclist sampling probability | [0, 1] |
| | other categories sampling | [0, 1] |
| | probability | |
| RandomFlip | flip probability | [0, 1] |
| WorldScaling | scaling range | [0.5, 1.5] |
| RandomRotation | maximum rotation angle | [0, π/4] |
| GlobalTranslateNoise | standard deviation of noise on | [0, 0.3] |
| | x axis | |
| | standard deviation of noise on | [0, 0.3] |
| | y axis | |
| | standard deviation of noise on | [0, 0.3] |
| | z axis | |
| FrustumDropout | theta angle width of the | [0, 0.4] |
| | selected frustum | |
| | phi angle width of the selected | [0, 1.3] |
| | frustum | |
| | distance to the selected point | [0, 50] |
| | the probability of dropping a | [0, 1] |
| | point | |
| | drop type⁶ | {‘union’, |
| | | ‘intersection’} |
| FrustumNoise | theta angle width of the | [0, 0.4] |
| | selected frustum | |
| | phi angle width of the selected | [0, 1.3] |
| | frustum | |
| | distance to the selected point | [0, 50] |
| | maximum noise level | [0, 1] |
| | noise type⁷ | {‘union’, |
| | | ‘intersection’} |
| RandomDropout | dropout probability | [0, 1] |

⁶Drop points in either the union or intersection of phi width and theta width.
⁷Add noise to either the union or intersection of phi width and theta width.

As described with reference to FIG. 3, the training system 220 may combine a predetermined number of point cloud augmentation policies generated by the training system 220 with the highest quality measures to generate the final point cloud augmentation policy. For point cloud augmentation policies having the form described above, multiple point cloud augmentation policies can be combined by concatenating their respective transformation operations into a single, combined point cloud augmentation policy.

FIG. 6 is a flow diagram of an example process for automatically selecting a point cloud augmentation policy and using the point cloud augmentation policy to train a machine learning model. For convenience, the process 600 will be described as being performed by a system of one or more computers located in one or more locations. For example, a system, e.g., the machine learning model training system 220 of FIG. 2, appropriately programmed in accordance with this specification, can perform the process 600.

The system receives training data (602) for training a machine learning model to perform a perception task by processing point cloud data. For example, the system may receive the training data through an API made available by the system. The training data includes multiple training examples, each of which specifies a training input and a corresponding target output. Each training input typically corresponds to a point cloud.

The system obtains candidate training data (604) that is used specifically in training candidate machine learning models during the policy search steps, i.e., steps 608-612 of process 600. For example, the system can obtain the candidate training data by randomly selecting a subset of the multiple training examples included in the received training data to use as the candidate training data.

The system identifies candidate evaluation data (606). The candidate evaluation data is composed of a plurality of training inputs that were not used in training the machine learning model. The system can identify the candidate evaluation data, e.g., by selecting training inputs on which a machine learning model that is trained without using point cloud augmentation policy fails to attain at least a threshold level of performance (e.g., lower than average prediction accuracy). In addition or instead, the system can specifically select training inputs whose point clouds possess one or more predetermined characteristics to use as candidate evaluation data. For example, the system identifies training inputs whose point clouds possess inclement weather characteristics, e.g., point clouds that characterize rainy day or snowy day environments.

The system repeatedly performs the steps 608-612 of the process 600 to generate a plurality of point cloud augmentation policies. In other words, the system performs steps 608-612 at each of multiple time steps. For convenience, each of the steps 608-612 will be described as being performed at a “current” time step.

The system determines a current point cloud augmentation policy (608). In some implementations, the system can do so by randomly sampling a set of point cloud augmentation policy parameters and respective values that in turn define the current point cloud augmentation policy.

In some implementations, the system generates the current point cloud augmentation policies based on quality measures of point cloud augmentation policies generated at previous time steps, e.g., by using a genetic programming procedure, an evolutionary search technique, a population based search technique, or a reinforcement learning based technique. Generating current point cloud augmentation policies using population based training techniques or reinforcement learning based techniques, in particular, are described in more detail with reference to FIG. 2.

For each current point cloud augmentation policy, the system trains a candidate machine learning model on the candidate training data using the current point cloud augmentation policy (610). Briefly, the training involves (i) generating augmented candidate training data by transforming the training inputs included in the candidate training data in accordance with the current point cloud augmentation policy, and (ii) adjusting current values of the candidate machine learning model parameters based on the augmented candidate training data.

In one example, the machine learning model is a neural network model and the system trains the neural network model over multiple training iterations. At each training iteration, the system selects a current mini-batch of one or more training examples from the candidate training data, and then determines an “augmented” mini-batch of training examples by transforming the training inputs in the current mini-batch of training examples using the current point cloud augmentation policy. Optionally, the system may adjust the target outputs in the current mini-batch of training examples to account for the transformations applied to the training inputs (as described earlier). The system processes the transformed training inputs in accordance with the current parameter values of the machine learning model to generate corresponding outputs. The system then determines gradients of an objective function that measures a similarity between: (i) the outputs generated by the machine learning model, and (ii) the target outputs specified by the training examples, and uses the gradients to adjust the current values of the machine learning model parameters. The system may determine the gradients using, e.g., a backpropagation procedure, and the system may use the gradients to adjust the current values of the machine learning model parameters using any appropriate gradient descent optimization procedure, e.g., an RMSprop or Adam procedure.

For each current point cloud augmentation policy, after the training, the system determines a quality measure of the current point cloud augmentation policy (612). Briefly, this involves (i) determining a performance measure of the candidate machine learning model on the perception task using the candidate evaluation data, and (ii) determining the quality measure based on the performance measure.

For example, the system can determine the performance measure by evaluating a F1 score or mean average precision score of the trained candidate machine learning model on the candidate evaluation data. In this way, the system determines the quality measure of a point cloud augmentation policy as a performance of a candidate machine learning model on the perception task using the candidate evaluation data as a result of training the candidate machine learning model using the current point cloud augmentation policy.

The system can repeatedly perform the steps 608-612 until a search termination criterion is satisfied (e.g., if the steps 608-612 have been performed a predetermined number of times).

After determining that a search termination criterion is satisfied, the system generates a final point cloud augmentation policy (614) from the plurality of point cloud augmentation policies and based on the quality measures. For example, the system may generate the final point cloud augmentation policy by combining (i.e., sequentially concatenating) a predetermined number of point cloud augmentation policies generated during steps 608-612 that have the highest quality measures.

The system generates a final trained machine learning model (616) by training a final machine learning model on the training data and using the final point cloud augmentation policy. In other words, the system generates an augmented set of training data by applying the final point cloud augmentation policy to training data, resulting in some or all of the training inputs included in the training data being augmented. The system then trains an instance of the machine learning model on the augmented training data. In some cases, the system may train the final machine learning model on the augmented training data for a larger number of training iterations than when the system trains candidate machine learning models using the “current” point cloud augmentation policies generated at step 606. For example, the system may train the final machine learning model on the augmented training data until a convergence criterion is satisfied, e.g., until the prediction accuracy of the final machine learning model reaches a minimum.

FIG. 7 is a flow chart of an example process 700 for updating the population repository for a candidate machine learning model. For convenience, the process 700 will be described as being performed by a system of one or more computers located in one or more locations. For example, a system, e.g., the machine learning model training system 220 of FIG. 3, appropriately programmed in accordance with this specification, can perform the process 700.

The system receives training data (702) for training a machine learning model to perform a machine learning task. For example, the system may receive the training data through an API made available by the system. The training data includes multiple training inputs, each of which may be associated with a corresponding target output. For example, the task can be a perception task, where the machine learning model is required to process point cloud data or other visual data including image or video data, for example to recognize objects or persons in the data. In this example, each training input can include data defining a point cloud, an image, or a video frame.

The system receives data defining a plurality of data augmentation policy parameters (704) such as point cloud augmentation policy parameters. Each data augmentation policy parameter may have a predetermined set of possible values. The data augmentation policy parameters can define multiple different transformation operations for transforming training inputs before the training inputs are used to train the machine learning model. The data augmentation policy parameters can also define, for each transformation operation, with which magnitude or with what probability or both should the transformation operation be applied.

The system maintains population data for a plurality of candidate machine learning models (706).

For each of the candidate machine learning models, the system maintains data that specifies: (i) respective values of model parameters for the candidate machine learning model, (ii) a subset of the transformation operations that will be used in the training of the candidate machine learning model, (iii) current values of the data augmentation policy parameters that define the subset of the transformation operations, and (iv) a performance measure of the candidate machine learning model on the machine learning task.

The system also maintains, for each type of the transformation operation, a quality measure of the transformation operation (708). The quality measure of a transformation operation generally corresponds to the performance measure (e.g., prediction accuracy) of a machine learning model trained using the transformation operation.

The system repeatedly (i.e., at each of multiple time steps) performs the following steps of 710-718 for each candidate machine learning model in the population repository. In particular, the system can repeatedly perform the following steps 710-718 for each candidate machine learning model asynchronously from performing the process for each other candidate machine learning model in the population repository.

For each of the plurality of candidate machine learning models and at each time step, the system determines a current augmented “batch” (i.e., set) of training data (710) in accordance with the current values of the plurality of data augmentation policy parameters.

Specifically, to determine the augmented batch of training data, the system can select a batch of training data, and then transform the training inputs in the batch of training data in accordance with current values of the data augmentation policy parameters that define the subset of the transformation operations. For each training input, the system can transform the training input by sequentially applying each of the one or more types of transformation operations to the training input, in accordance with the transformation operation probability, the transformation operation magnitude, or both as defined by the data augmentation policy parameters.

In this way, the system transforms at least some of the existing training inputs from the training data to generate “new” training inputs, and uses the new training inputs (instead of or in addition to the existing training inputs) to train the candidate machine learning model. For example, a point cloud included in a training input can be transformed by applying one or more point cloud transformation operations specified by the point cloud augmentation policy parameters to the point cloud.

In some cases, the training input can be transformed (e.g., in accordance with the data augmentation policy parameters) while maintaining the same corresponding target output. For example, for a point cloud classification task where the target output specifies a type of object depicted in the training input, applying point cloud transformation operations (e.g., intensity perturbing, jittering, dropping out, and the like) to the point cloud included in the training input would not affect the type of object depicted in the point cloud. Therefore, in this example, the transformed training input would correspond to the same target output as the original training input.

However, in certain situations, transforming the training input may also require changing the target output of the training example. In one example, the target output corresponding to a training input may specify coordinates of a bounding box that encloses an object depicted in the point cloud of the training input. In this example, if the data augmentation policy parameters define at least a translation operation to the point cloud, then transforming the training input would require applying the same translation operation to the bounding box coordinates specified by the target output.

The system trains the candidate machine learning model using the augmented batch of the training data (712). Training the candidate machine learning model refers to iteratively determining adjusted (e.g., trained) values of the model parameters of the machine learning model starting from the maintained values of the parameters of the candidate machine learning model.

To train the candidate machine learning model, the system can process the training inputs (e.g., transformed training inputs) in accordance with the current parameter values of the machine learning model to generate corresponding outputs. The system then determines gradients of an objective function that measures a difference (e.g., in terms of mAP score, F1 score, or mean squared error) between: (i) the outputs generated by the candidate machine learning model, and (ii) the target outputs associated with the training inputs, and uses the gradients to adjust the current values of the machine learning model parameters. The system may determine the gradients using, e.g., a backpropagation procedure, and the system may use the gradients to adjust the current values of the machine learning model parameters using any appropriate gradient descent optimization procedure, e.g., an RMSprop or Adam procedure.

Termination criteria are one or more conditions set, that when met by a candidate machine learning model, cause the system to update the repository for the candidate machine learning model, with new model parameters, data augmentation policy parameters, and the performance measure, and to update the quality measures of the transformation operations. An example of a termination criterion being met is when a candidate machine learning model has been training for a set period of time or a fixed number of iterations of the iterative training process. Another example of a termination criterion being met is when a candidate machine learning model falls below a certain performance threshold. In those cases, the system continues to perform the following steps to update the repository data for the candidate machine learning model, as well as to update the quality measures of the transformation operations.

The system determines an updated performance measure for the candidate machine learning model in accordance with the updated values of the parameters for the candidate machine learning model (714). In other words, the system takes the updated values of the model parameters determined in step 712 to determine the updated quality measure for the candidate machine learning model. For example, the system can determine the performance measure (e.g., mAP score, F1 score, or mean squared error) of the trained candidate machine learning model on a set of evaluation data composed of multiple training inputs that are not used to train the candidate machine learning model.

The system determines an updated quality measure for each of the subset of transformation operations (716) that have been used in training the candidate machine learning model. The updated quality measure of the type of transformation operation can be determined from the updated performance measure of a candidate machine learning model trained using at least a transformation operation of this type.

The system uses the information determined from steps 714-716 to update the repository for the candidate machine learning model (718) to specify, i.e., to either replace existing data or add as new data, (i) the updated values of the model parameters and (ii) the updated performance measure.

In particular, the system can compare respective performance measures of the candidate machine learning model and another candidate machine learning model in the population and then select, based on the result of the comparison, either the values of the parameters of the candidate machine learning model (i.e., determined as of the current time step), or the values of the parameters of the other candidate machine learning model as the updated values of parameters for the candidate machine learning model. Specifically, if the performance measure of the candidate machine learning model is better than the performance measure of the other candidate machine learning model, then values of the model parameters of the candidate machine learning model may be selected as the updated values of the model parameters.

During comparison, the other candidate machine learning model can be a model that is different from the candidate machine learning model in the population and is, for example, randomly selected by the system from the remaining plurality of candidate machine learning models in the population

The system also updates the repository to specify an updated subset of the transformation operations for use in training the candidate neural network in the next time step, i.e., to specify updated data augmentation policy parameters, based on the maintained quality measures for the population of candidate machine learning models in the population repository including the updated performance measures determined at step 714, and updated quality measures determined at step 716.

Determining updated data augmentation policy parameters similarly involves comparing respective performance measures of the candidate machine learning model and the other candidate machine learning model, and thereafter using (e.g., through mutation and reproduction) the data augmentation policy parameters used in training the well-performing model to improve the training of the candidate machine learning model for the next time step, i.e., by generating transformation operations with higher quality measures.

Specifically, if the performance measure of the candidate machine learning model is better than the performance measure of the other candidate machine learning model, then data augmentation policy parameters that define the subset of transformation operations used in training the candidate machine learning model may be selected as the updated data augmentation policy parameters.

Alternatively, if the performance measure of the candidate machine learning model is not better than the performance measure of the other candidate machine learning model, the system first identifies, as the updated subset of the transformation operations for use in training the candidate neural network in the next time step, the maintained subset of the transformation operations for the other candidate machine learning model.

For each transformation operation in the updated subset of the transformation operations, the system can then select data augmentation policy parameters that define the transformation operation based on the maintained data augmentation policy parameters for the other candidate machine learning model. Additionally or alternatively, for each augmentation operation that is not in the updated subset, the system can select values for the data augmentation policy parameters that define the augmentation operation based on the maintained quality measures.

Finally, the system generates the updated data augmentation policy parameters by mutating the selected data augmentation policy parameters. Example parameter mutation techniques include randomly perturbing the parameter value, e.g., according to some predetermined multiplier, randomly sampling from a set of possible parameter values, and restricting the parameter value to some predetermined threshold value.

After executing step 718, the system can return to step 710, and the iterative training process continues. Specifically, the system continues to train the candidate machine learning model using the updated data augmentation policy parameters and updated model parameters of the candidate machine learning model, to iteratively generate updated model parameters for the candidate machine learning model.

The system will continue the iterative training process for the candidate machine learning model until either the termination criteria is satisfied (and the system repeats the steps 710-718 for the candidate machine learning model) or performance criteria is satisfied to indicate to the system to stop training.

When training is over, the system generates data specifying a trained machine learning model by selecting the candidate machine learning model from the population with the highest performance measure.

In some implementations, the system additionally generates a final data augmentation policy. For example, the final data augmentation policy can be presented in the form of a schedule of changes of data augmentation parameters over an entire course of multiple time steps in which the candidate machine learning models are trained. As another example, the final data augmentation policy can be presented in the form of a sequence of one or more transformation operations, which has been generated by the system from the plurality of data augmentation policy parameters and based on the maintained quality measures of the transformation operations, e.g., by selecting the respective parameters that define the one or more of the different transformation operations having highest quality measures.

In some such implementations, instead of directly outputting data specifying the final trained machine learning model determined at the end of the iterative training process, the system can further fine-tune the trained model values the final data augmentation policy by additionally training the final trained machine learning model using the final data augmentation policy.

An example algorithm for updating the population repository for a candidate machine learning model using the disclosed progressive population-based augmentation technique is shown below.

Algorithm 1
Progressive Population Based Augmentation

```
Input: data and label pairs (χ, [symbol]   )
Search Space: [symbol]   = {opᵢ : paramsᵢ}ᵢ₌₁ⁿ
Set t = 0, num_ops = 2, population [symbol]  = { }, best params and metrics
for each operation historical_op_params = { }
while t ≠ [symbol]   do
  for [symbol]   in {θ₁^{t}, θ₂^{t}, . . . , [symbol] } (asynchronously in parallel) do
    # Initialize models and augmentation parameters in current iteration
    if t == 0 then
      op_ [symbol]  = Random.sample( [symbol] , num_ops)
      Initialize θᵢ^{t}, λᵢ^{t}, params of op_paramsᵢ^{t}
      Update λᵢ^{t} with op_paramsᵢ^{t}
    else
      Initialize θᵢ^{t} with the weights of winnerᵢ^{t-1}
      Update λᵢ^{t} with λᵢ^{t-1} and op_paramsᵢ^{t}
    end if
    # Train and evaluate models, and update the population
    Update θᵢ^{t} according to formular (2)
    Compute metric Ωᵢ^{t} = Ω(θᵢ^{t})
    Update historical_op_params with op_paramsᵢ^{t} and Ωᵢ^{t} [symbol]
    ← [symbol]  ∪ {θᵢ^{t}}
    # Replace inferior augmentation parameters with better ones
    winnerᵢ^{t} ← Complete(θᵢ^{t}, Random.sample( [symbol]  ))
    If winnerᵢ^{t} ≠ θᵢ^{t} then
      op_parensᵢⁱ⁺¹ ← Mutate(winnerᵢ^{t}'s op_params,
      historical_op_params)
    else
      op_paramsᵢ^{t+1} ← op_paramsᵢ^{t}
    end if
  end for
  t ← i + 1
end while [symbol]
indicates data missing or illegible when filed
```

During search, the training process of multiple machine learning models is split into N time steps. At every time step, M models with different λₜ are trained in parallel and are afterwards evaluated with a given metric χ. Models trained in all previous iterations are placed in a population P.

The search process involves maximizing the given metric χ on a machine learning model parameterized by model parameters θ by optimizing a schedule of data augmentation policy parameters λ=(λₜ)ₜ₌₁^{T}, where t represents the number of iterative updates for the data augmentation policy parameters during model training. For example, for object detection tasks, mean average precision (mAP) can be used as the performance metric. The search process for the best augmentation schedule λ* optimizes:

$${λ}^{*} = arg {max}_{λ ∈ {A}^{T}} Ω ( θ ) . \qquad ( 1 )$$

During training, the objective function L (which is used for optimization of the model parameters θ given training input and target output pairs (X, Y)) is usually different from the actual performance metric χ, since the optimization procedure (e.g., stochastic gradient descent) requires a differentiable objective function. Therefore, at each time step t, the model parameters 0 can be optimized according to:

$${θ}_{t}^{*} = arg {min}_{θ ∈ ⊖} L ( x , y , {λ}^{t} ) . \qquad ( 2 )$$

An example algorithm for generating new data augmentation policy parameters during the search is shown below.

Algorithm 2
Exploration Based on Historical Data

```
Input: op_params = {opᵢ : paramsᵢ}ᵢ₌₁^{num}_ops, best params and metric for
each operation historical_op_params
Search Space: [symbol]  = {(opᵢ, paramsᵢ)}ᵢ₌₁ⁿ
Set exporation_rate = 0.8, selected_ops = [ ], new_op_params { }
If Random(0, 1) < exploration_rate then
  selected_ops = op_params.Keys( )
else
  selected_ops = Random.sample( [symbol] .Keys( ), num_ops)
end if
for i in Range(num_ops) do
  # Choose augmentation parameters, which successors will mutate
  # to generate new parameters
  if selected_ops[i] in op_params.Keys( ) then
    parent_params = op_params[selected.ops[i]]
  else if selected_ops[i] in historical_op_params.Keys( ) then
    parent_params = historical_op_params[selected.ops[i]]
  else
    Initialize parent_params randomly
  end if
  new_op_params[selected_ops[i]] = MutateParams(parent_params)
end for
```

In the initial iteration, all model parameters and data augmentation policy parameters are randomly initialized. After the first iteration, model parameters are determined through an exploit phase, i.e., inheriting from a better performing parent model by exploiting the rest of the population P. The exploit phase is followed by an exploration phase, in which a subset of the transformation operations will be explored for optimization by mutating the corresponding data augmentation policy parameters used in training the parent model, while the remaining data augmentation policy parameters will be directly inherited from the parent model.

During the exploit phase, data augmentation policy parameters used in training the well-performing models are retained, and data augmentation policy parameters used in training the less-well-performing models are replaced at the end of every iteration. In particular, the proposed method focuses only on a subset of, i.e., rather than the entirety of, the search space at each iteration. During the exploration phase, a successor might focus on a different subset of the data augmentation policy parameters than its predecessor. In that case, the remaining data augmentation policy parameters (parameters that the predecessor does not focus on) are mutated based on the data augmentation policy parameters of the corresponding operations with the best overall performance.

FIG. 8 is an illustration of an example iteration of generating new data augmentation policy parameters.

In the example of FIG. 8, the plurality of data augmentation policy parameters define a total of four different transformation operations (a1, a2, a3, a4) that can each be applied to the input inputs during training. During search, two augmentation operations out of the total of four different transformation operations are explored for optimization at every iteration. For example, at the beginning of iteration t−1, data augmentation policy parameters associated with transformation operations (a1, a2) are selected for exploration for the model 810, while data augmentation policy parameters associated with transformation operations (a3, a4) are selected for exploration for the model 820. At the end of training in iteration t−1, a less-well-performing model, i.e., the model 820 in this example, is exploited by the model with better performance, i.e., the model 810.

Next, a successor model can inherit both model parameters and data augmentation policy parameters from the winner model, i.e., the model 810 in this example. During the exploration phase, the augmentation operations (a2, a3) can be selected, i.e., through random data augmentation policy parameter sampling, for exploration by the successor model. Because data augmentation policy parameters associated with the transformation operation a3 have not been explored by the predecessor model, i.e., the model 820, corresponding data augmentation policy parameters of the best-performing model, i.e., the model 830 in this example, in which a3 has been selected for exploration, will be adopted for exploration by the successor model, i.e., the model 840.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving training data for training a machine learning model to perform a particular machine learning task, the training data comprising a plurality of training inputs;
receiving a plurality of data augmentation policy parameters that define different transformation operations for transforming training inputs before the training inputs are used to train the machine learning model;
maintaining a plurality of candidate machine learning models and, for each of the candidate machine learning models, data specifying: (i) respective values of parameters for the candidate machine learning model, (ii) a subset of the transformation operations, (iii) current values of the data augmentation policy parameters that define the subset of the transformation operations, and (iv) a performance measure of the candidate machine learning model on the particular machine learning task;
maintaining, for each of the different transformation operations, a quality measure of the transformation operation;
repeatedly performing the following operations at each of multiple time steps:
for each of the plurality of candidate machine learning models:
determining an augmented batch of training data by transforming at least some of the training inputs in the training data in accordance with at least the current values of the plurality of data augmentation policy parameters;
training the candidate machine learning model using the augmented batch of the training data to determine updated values of the parameters for the candidate machine learning model from the maintained values of the parameters for the candidate machine learning model;
determining an updated performance measure for the candidate machine learning model in accordance with the updated values of the parameters for the candidate machine learning model;
determining an updated quality measure for each of the subset of transformation operations;
updating the maintained data to specify (i) new values of the parameters for the candidate machine learning model, (ii) a new subset of the transformation operations, and (iii) a new performance measure, comprising:
selecting, based on comparing respective performance measures of the candidate machine learning model and another candidate machine learning model, either the values of the parameter of the candidate machine learning model or the values of the parameters of the other candidate machine learning model as new values of parameters for the candidate machine learning model; and
selecting, based on comparing respective performance measures of the candidate machine learning model and the other candidate machine learning model, new data augmentation policy parameters from the plurality of data augmentation policy parameters.

2. The method of claim 1, further comprising, after repeatedly performing the following operations:
determining, from the plurality of data augmentation policy parameters and based on the maintained quality measures of the transformation operations, a final data augmentation policy.

3. The method of claim 2, wherein determining the final data augmentation policy comprises:
selecting the respective parameters that define one or more of the different transformation operations having highest quality measures.

4. The method of claim 1, wherein repeatedly performing the following operations at each of multiple time steps comprises repeatedly performing the following operations in parallel for each candidate machine learning model.

5. The method of claim 1, wherein for each transformation operation, the data augmentation policy parameters further define at least one of: (i) a probability of the transformation operation, or (ii) a magnitude of the transformation operation.

6. The method of claim 1, further comprising, for a first step in the multiple time steps:
for each of the plurality of the candidate machine learning models:
initializing one or more transformation operations by randomly sampling data augmentation policy parameters.

7. The method of claim 1, wherein the candidate machine learning model is a neural network, and training the candidate machine learning model comprises:
determining a gradient of a loss function using the augmented batch of training data; and
adjusting the current values of the parameters of the candidate machine learning model using the gradient.

8. The method of claim 1, wherein determining the augmented batch of training data by transforming at least some of the training inputs in the training data in accordance with the plurality of data augmentation policy parameters comprises:
selecting a batch of training data; and
transforming the training inputs in the batch of training data in accordance with the plurality of data augmentation policy parameters, comprising, for each training input:
transforming the training input by sequentially applying each of the different transformation operations defined by the plurality of data augmentation policy parameters to the training input.

9. The method of claim 8, wherein applying a transformation operation to the training input comprises:
applying the transformation operation with the transformation operation probability, the transformation operation magnitude, or both to the training input.

10. The method of claim 1, wherein determining the updated performance measure for the candidate machine learning model in accordance with the updated values of the parameters for the candidate machine learning model comprises:
determining the updated performance measure of the candidate machine learning model on the particular machine learning task using evaluation data comprising a plurality of training inputs.

11. The method of claim 10, wherein the training inputs included in the evaluation data are not included in the training data.

12. The method of claim 1, wherein:
the quality measure for each transformation operation represents a performance of a candidate machine learning model on the particular machine learning task as a result of training the candidate machine learning model using at least the transformation operation.

13. The method of claim 1, wherein selecting new data augmentation policy parameters comprises, for each of the subset of transformation operations:
if the performance measure of the candidate machine learning model is better than the performance measure of the other candidate machine learning model:
selecting data augmentation policy parameters that define the subset of transformation operations as the new data augmentation policy parameters.

14. The method of claim 13, wherein selecting new data augmentation policy parameters comprises:
if the performance measure of the candidate machine learning model is not better than the performance measure of the other candidate machine learning model:
identifying, as the new subset for the candidate machine learning model, the maintained subset of the transformation operations for the other candidate machine learning model;
selecting, for each of the new subset of the transformation operations, data augmentation policy parameters that define the transformation operations based on the maintained data augmentation policy parameters for the other candidate machine learning model; and
generating the new data augmentation policy parameters by mutating the selected data augmentation policy parameters.

15. The method of claim 14, wherein selecting new data augmentation policy parameters comprises:
for each augmentation operation that is not in the new subset, selecting values for the data augmentation policy parameters that define the augmentation operation based on the maintained quality measures.

16. The method of claim 2, further comprising:
generating a final trained machine learning model by training a final machine learning model using the final data augmentation policy.

17. The method of claim 1, wherein the training inputs are images or point clouds.

18. The method of claim 1, wherein the particular machine learning task is a perception task comprising classification or regression.

19. The method of claim 1, further comprising, for the candidate machine learning model:
randomly selecting a candidate machine learning model from the remaining plurality of candidate machine learning models as the other candidate machine learning mode.

20. A system comprising one or more computers and one or more storage devices storing instructions that when executed by the one or more computers cause the one more computers to perform operations for:
receiving training data for training a machine learning model to perform a particular machine learning task, the training data comprising a plurality of training inputs;
receiving a plurality of data augmentation policy parameters that define different transformation operations for transforming training inputs before the training inputs are used to train the machine learning model;
maintaining a plurality of candidate machine learning models and, for each of the candidate machine learning models, data specifying: (i) respective values of parameters for the candidate machine learning model, (ii) a subset of the transformation operations, (iii) current values of the data augmentation policy parameters that define the subset of the transformation operations, and (iv) a performance measure of the candidate machine learning model on the particular machine learning task;
maintaining, for each of the different transformation operations, a quality measure of the transformation operation;
repeatedly performing the following operations at each of multiple time steps:
for each of the plurality of candidate machine learning models:
determining an augmented batch of training data by transforming at least some of the training inputs in the training data in accordance with at least the current values of the plurality of data augmentation policy parameters;
training the candidate machine learning model using the augmented batch of the training data to determine updated values of the parameters for the candidate machine learning model from the maintained values of the parameters for the candidate machine learning model;
determining an updated performance measure for the candidate machine learning model in accordance with the updated values of the parameters for the candidate machine learning model;
determining an updated quality measure for each of the subset of transformation operations;
updating the maintained data to specify (i) new values of the parameters for the candidate machine learning model, (ii) a new subset of the transformation operations, and (iii) a new performance measure, comprising:
selecting, based on comparing respective performance measures of the candidate machine learning model and another candidate machine learning model, either the values of the parameter of the candidate machine learning model or the values of the parameters of the other candidate machine learning model as new values of parameters for the candidate machine learning model; and
selecting, based on comparing respective performance measures of the candidate machine learning model and the other candidate machine learning model, new data augmentation policy parameters from the plurality of data augmentation policy parameters.

21. One or more computer storage media storing instructions that when executed by one or more computers cause the one more computers to perform operations for:
receiving training data for training a machine learning model to perform a particular machine learning task, the training data comprising a plurality of training inputs;
receiving a plurality of data augmentation policy parameters that define different transformation operations for transforming training inputs before the training inputs are used to train the machine learning model;
maintaining a plurality of candidate machine learning models and, for each of the candidate machine learning models, data specifying: (i) respective values of parameters for the candidate machine learning model, (ii) a subset of the transformation operations, (iii) current values of the data augmentation policy parameters that define the subset of the transformation operations, and (iv) a performance measure of the candidate machine learning model on the particular machine learning task;
maintaining, for each of the different transformation operations, a quality measure of the transformation operation;
repeatedly performing the following operations at each of multiple time steps:
for each of the plurality of candidate machine learning models:
determining an augmented batch of training data by transforming at least some of the training inputs in the training data in accordance with at least the current values of the plurality of data augmentation policy parameters;
training the candidate machine learning model using the augmented batch of the training data to determine updated values of the parameters for the candidate machine learning model from the maintained values of the parameters for the candidate machine learning model;
determining an updated performance measure for the candidate machine learning model in accordance with the updated values of the parameters for the candidate machine learning model;
determining an updated quality measure for each of the subset of transformation operations;
updating the maintained data to specify (i) new values of the parameters for the candidate machine learning model, (ii) a new subset of the transformation operations, and (iii) a new performance measure, comprising:
selecting, based on comparing respective performance measures of the candidate machine learning model and another candidate machine learning model, either the values of the parameter of the candidate machine learning model or the values of the parameters of the other candidate machine learning model as new values of parameters for the candidate machine learning model; and
selecting, based on comparing respective performance measures of the candidate machine learning model and the other candidate machine learning model, new data augmentation policy parameters from the plurality of data augmentation policy parameters.
